(19) United States
(12) Patent Application Publication
(10) Pub. No.: US 2025/0094942 A1
(43) Pub. Date: Mar. 20, 2025

(54) CHECK FRAUD PREVENTION SYSTEM

(71) Applicant: Emil Ramzy, Hacienda Heights, CA (US)

(72) Inventor: Emil Ramzy, Hacienda Heights, CA (US)

(21) Appl. No.: 18/369,027

(22) Filed: Sep. 15, 2023

(51) Int. Cl. G06Q 20/04; G06Q 20/38

(52) U.S. Cl. CPC G06Q 20/042; G06Q 20/3825

(57) ABSTRACT

The present invention discloses a method that provides improved entry point verification to determine if fraudulent checks are presented. It utilizes special computer software programs that are incorporated into current banking computer software for printing checks and processing checks, and at merchant retailers. The method prints on each issued check, a line of machine-only readable symbols such as a bar-code or QR code that contains all the information printed on the check plus unseen additional information not printed on the face of the check, using a special, key-selectable encryption algorithm. When a check is presented to a bank teller or a cashier, a reader/decoder device connected to a computer will read the line of encrypted data and identify a fraudulent check for rejection.

### BACKGROUND OF THE INVENTION

### 1. Field of the Invention

The invention relates to bank systems for printing and processing checks and to merchant check verification systems, and more particularly to a check fraud prevention method for incorporation in existing systems for printing, processing and verifying checks.

### 2. Background

Check fraud continues to cost companies billions. In fact, according to the Association for Financial Professionals' (hereinafter referred to as AFP) 2020 Payments Fraud and Control Survey, 74% of companies that experienced attempted or actual payments fraud last year were victims of check fraud. Despite the risk, the AFP found that 42% of companies use checks for business-to-business payments. In the United States, the incorporation of bar codes on checks to prevent check fraud has gained momentum with the implementation of Magnetic Ink Character Recognition (MICR) technology. This technology, using magnetic ink allowing banks to efficiently process and sort checks using automated equipment. The bar codes contained information such as the routing number, account number, and check number, all printed in a format that may be easily read by machines.

The adoption of bar codes on checks increased the speed and accuracy of check processing. It helped to streamline operations and reduce manual errors. With bar codes, banks could automatically capture essential information from checks, making tasks such as depositing, clearing, and reconciling checks more efficient. With the proliferation of digital banking and electronic payment systems, the prominence of physical checks has decreased. However, many banks still rely on bar code technology as part of their check processing operations to ensure accurate and efficient check clearing processes. Advanced image recognition and optical character recognition (OCR) technologies have complemented bar codes, allowing banks to quickly and accurately capture check information, even from mobile check deposits or scanned images.

Therefore, advanced check production systems printing the MICR (Magnetic Character Recognition) codes have been developed, and many special check papers used by banks are widely available. However, this makes a counterfeiters job easier for the production of counterfeit checks. More specifically, a typical check scam is for a counterfeiter to obtain temporarily, a bank check or company paycheck from an individual, and then to counterfeit the check, copying everything but the name and check amount. Names and amounts may then be added to such checks, and the checks cashed. This and similar check counterfeit techniques are difficult for present bank check verification systems to detect. There are, at present, very few readily available methods available to banks for effectively blocking counterfeiters and preventing continuing check fraud.

One such known bank check verification system to prevent check fraud is disclosed in U.S. Pat. No. 6,073,121 issued to Emil Ramzy, the inventor of the present invention and provides a method for a check fraud prevention system both in printing and verifying checks at their entry points. The method operates by printing on each issued check, a line of encrypted machine-only readable symbols such as a bar-code that contains all the information printed on the check, using a special, key-selectable encryption algorithm. When a check is presented to a bank teller or a cashier, a required, modified reader/decoder device connected to a computer reads the line of encrypted data and identifies a fraudulent check for rejection.

Although the method taught by the inventor of the current invention's prior art patent may be useful in combatting check fraud, particularly those involving personal checks, it still may not be effective in preventing bank check or company paycheck fraud scams. Using the improved method of the present invention there is provided a check fraud prevention system that is further capable of preventing fraud on bank checks and industry wide checks as well as on personal checks.

### SUMMARY OF THE INVENTION

The present invention discloses a method that provides improved entry point verification to determine if fraudulent checks are presented. It utilizes special computer software programs that are incorporated into current banking computer software for printing checks and processing checks, and at merchant retailers. The method prints on each issued check, a line of machine-only readable symbols such as a bar-code or QR code that contains all the information printed on the check plus unseen additional information not printed on the face of the check, using a special, key-selectable encryption algorithm. When a check is presented to a bank teller or a cashier, a reader/decoder device connected to a computer will read the line of encrypted data and identify a fraudulent check for rejection. Therefore, the present invention provides a method for quickly detecting counterfeited or altered checks and immediately rejecting them.

Further objects and advantages of the present invention will be apparent from study of the specification description, the claims and the attached drawings.

### BRIEF DESCRIPTION OF THE DRAWINGS

FIG. 1 is a perspective view of the equipment used for the verification of checks according to the present invention, particularly showing a check about to be placed in a check reader/decoder for scanning check data;

FIG. 2 is a front face view of a check, particularly showing a typical barcode which is one form of machine-only readable symbols, containing encrypted check data which is printed on checks in accordance with the present invention;

FIG. 3 is a front face view of a check, particularly showing a typical QR code which is one form of machine-only readable symbols, containing encrypted check data which is printed on checks in accordance with the present invention;

FIG. 4 is a block diagram flow chart of an improvement to a bank check printing system, incorporating a procedure for reading and converting all check face data to a line of encrypted machine-only readable symbols, according to the present invention;

FIG. 5 and FIG. 6 are respectively, the first and second parts of a block diagram flow chart, illustrating a system procedure for bank teller verification of a customer presented check according to the present invention; and

FIG. 7 is a block diagram flow chart, illustrating a system procedure for merchant verification of a customer presented check, according to the present invention.

### DESCRIPTION OF THE PREFERRED EMBODIMENT

Referring now to in FIG. 1, there is shown a perspective view of a typical bank or merchant equipment for verifying checks employing the method of the present invention method. The equipment is a monitor 1, a PC unit 9 and a check reader/decoder 3 which is connected input to the PC 9. To use the equipment, a check 5 is passed through a slot 7 in the reader/decoder 3, which, using one or more additional reading heads, scans all the data on the check, decodes any encrypted symbols and then passes the information to the PC 9 for processing. The PC 9 then displays information on the monitor for the teller or cashier to act on or to review. For example, a keyboard entry input may be requested or a simple “Check OK” or “Reject check” may be displayed.

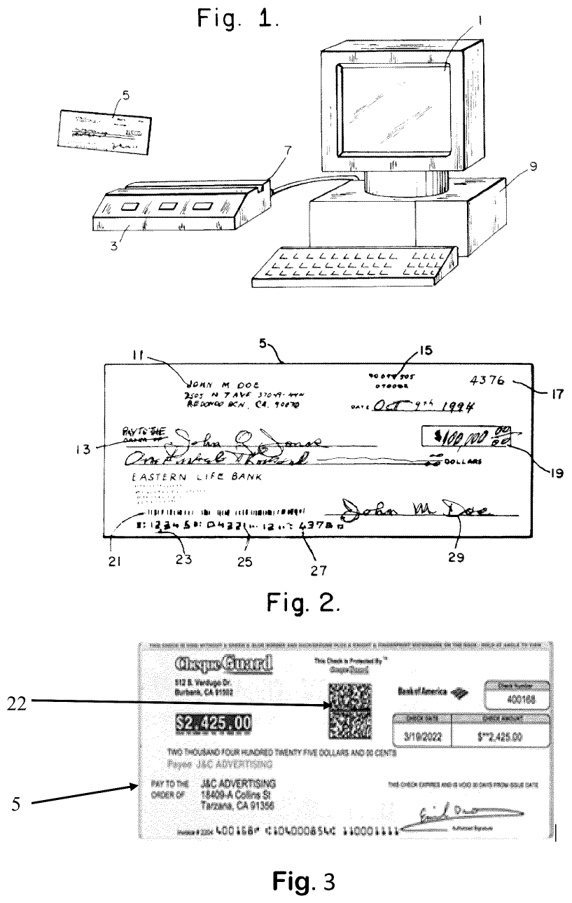

Turning now to FIG. 2 is a view of the face of a check 5 that is printed using the present invention method and which may be presented for entry point verification. On the face of the check are the following data items: the name and address of the account owner 11; the name of the payee 13; the issuing bank number 15; a check number 17; the check date; the check amount 19; a line of bar-code symbols 21 containing check data; the name of the issuing bank; an MICR line showing the check number 23, the transit number 25 and the record number 27; and the signature of the payer 29.

In the case of bank checks or industry printed checks, such as pay checks or checks made for goods or services, all the printed check face data listed above would be encrypted, using a special, key-selectable algorithm. A representative machine-readable only bar-code line 21 or any other selected machine-readable only symbol(s) containing the encrypted data, would be printed on the check face above the MICR line. Referring now to FIG. 3, there is shown in place of using the bar-code line 21 shown in FIG. 2, a QR code 22 placed and printed at the center of check 5 containing the same data entry fields as bar-code line 21.

In accordance with the improved method of the present invention, for personal checks, the check date, payee name, check amount and payer signature will be included in the printed bar-code above the MICR line and or included in the center printed QR code 22 in lieu of the printed bar-code 21. Additionally, and as a further security measure and with the permission of the check account owner, an account PIN number may be included to aid in verification of the check signatory identity. More particularly, for personal, pre-printed and blank checks, a barcode 21 or QR code is printed on the check wherein the payload of either the barcode 21 or QR code 22 contains the following encrypted data:
Check's owner.
Account number.
Routing number.
Check number.
PIN number (like ATM card PIN).
Authorized signature, and/or

Also, in accordance with the improved method of the present invention, for business checks, the check date, payee name, check amount, payer signature and manufacturer's identification will be included in the printed bar-code above the MICR line and or included in the center printed QR code 22 in lieu of the printed bar-code 21. More particularly, for business checks, a barcode 21 or QR code 22 is printed on the check wherein the payload of either the barcode 21 or QR code 22 contains the following encrypted data:
Payee Name.
Check Amount.
Check number.
Routing number.
Check date.
Account number.
Signature(s).
User's ID that printed the check.
Date and time the check is printed.
Printer ID used to print the check, and/or
Internal tracking number for the check like claim number, invoice number.

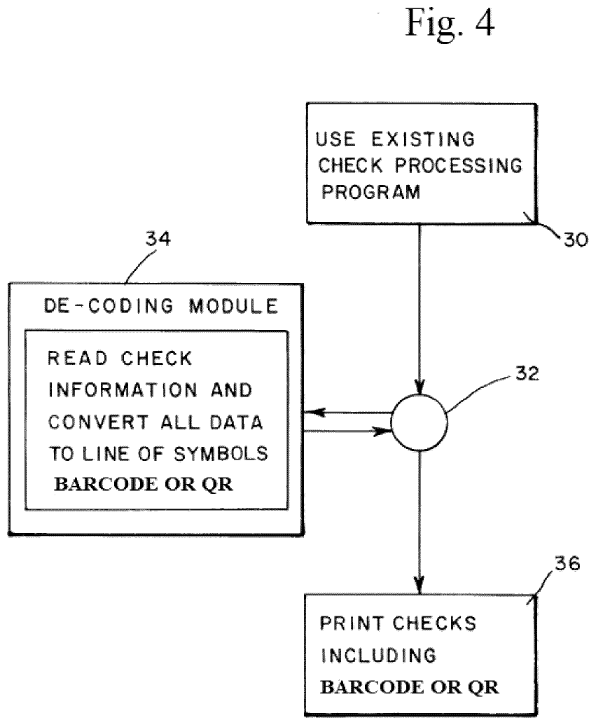

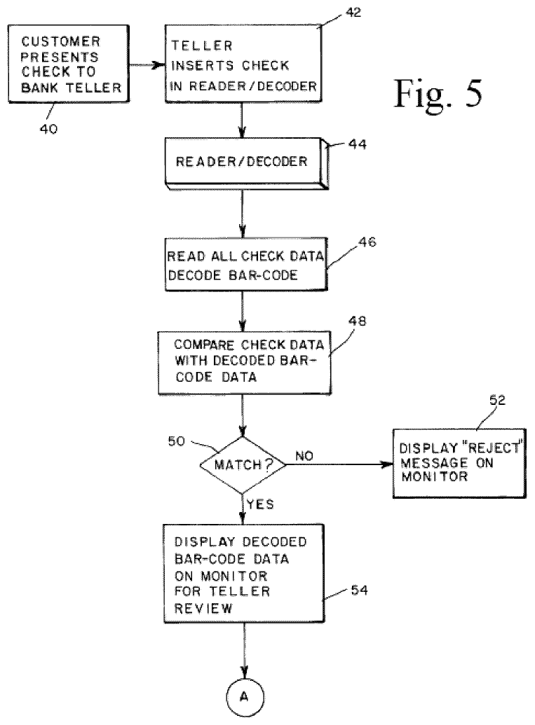

Referring now to FIG. 4 there are illustrated the major steps in a check printing program in accordance with a method of the present invention. Initially, the steps of an existing check processing program 30 are performed. The input check information printed on the check face and non-printed check information is sent to a printer for printing in a desired format. During this time, the check's information both printed and non-printed information stream 32 is also passed to a decoding module 34 which uses a special key-selectable algorithm to convert all the data to machine only readable symbol(s), such as a bar-code or QR code. This line of symbols or bar-code is then printed 36 on the check face just above the MICR (Magnetic Ink Character Recognition) line located at the bottom of the check face or in a QR code printed at the center of the check.

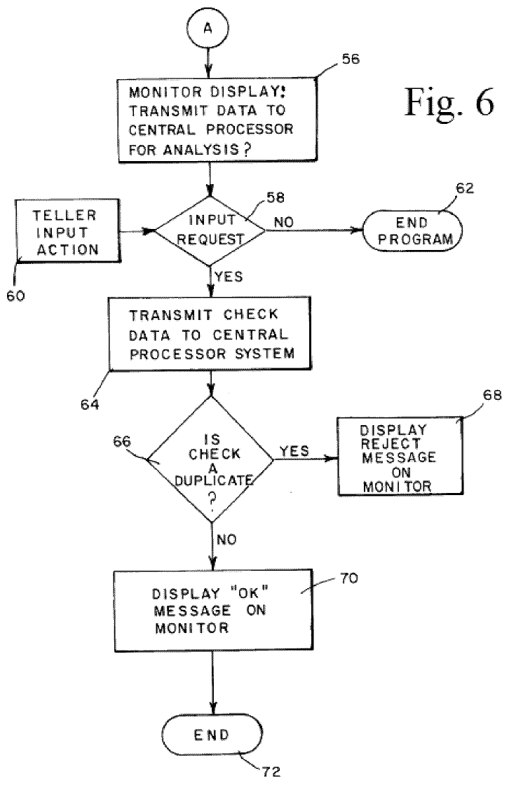

Referring now to FIGS. 5 and 6 which are respectively, the first and second parts of a simplified flow chart, illustrate the steps taken using the method of the present invention when a check is presented to a bank teller for verification and processing. The method is as follows:
1. The customer first presents a check to a bank teller 40.
2. The teller inserts the presented check 42 in a reader/decoder 44 for scanning.
3. The reader/decoder 44 reads all printed check data and decodes 46 the symbol line (bar-code) that is above the MICR line or the QR code printed at the center of the check.
4. The computer compares the printed check data with the decoded QR symbol or bar-code line 48.
5. The computer decides if the printed and decoded data match 50.
6. If no match is found or no barcode or QR code is found indicates a counterfeit check, the computer displays a “Reject” message on the monitor 52.
7. If a match is found, the monitor displays the decoded QR symbol or bar-code line data on the monitor for the teller review 54.
8. After a short period of time for teller review of the displayed data, the monitor displays a request for teller input: “(Do you want to) transmit the data to the central processor for analysis?. Input Yes or No.” This action is at the discretion of the teller who may suspect that the check is a duplicate, or has some other hidden and undetected error.
9. The teller keyboard inputs a reply 60 to the computer 58.
10. If the teller input reply 60 is “No”, the program is ended 62.
11. If the teller input reply is “Yes”, the check data is transmitted to a central processing system for analysis.
12. The computer then queries the central processing system 66: “Is the check a duplicate? Or is there any other reason to reject it?”.
13. If the answer is “Yes”, the monitor displays a “Reject” message 68.
14. If the answer is “No”, the monitor displays an “OK” message 70, and ends the program 72.

It should be understood that there may actually be many more steps in the method of the present invention that may be carried out for further check verification purposes. The steps listed above in the discussion of the flow chart are only the essential required steps and are discussed to particularly point out and teach how the method is incorporated for check verification.

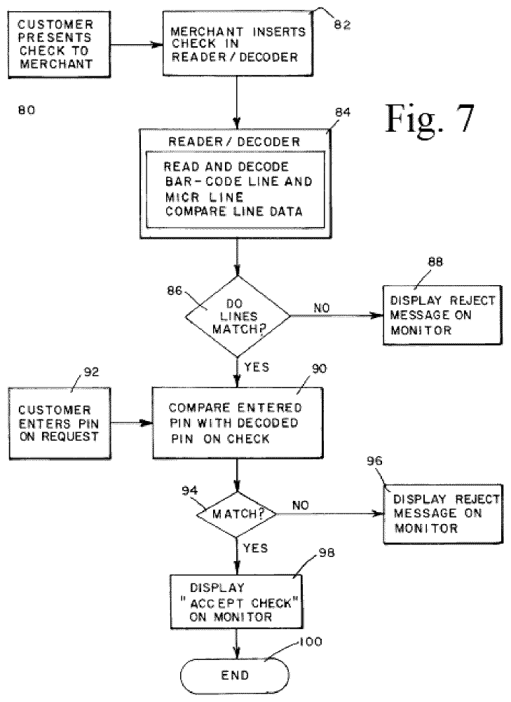

Referring now to FIG. 7, there is shown a simplified flow chart of the method for check verification and fraud prevention that would be used by a merchant or retailer entry point, The method is as follows:
1. A customer presents a check to a merchant 80.
2. The merchant inserts the check in a reader/decoder for scanning 82.
3. The reader/decoder reads and decodes the check for a QR symbol or barcode located above the MICR line, and also reads the MICR line, comparing the bar-code line with the MICR line data or QR code 84, to determine if they match 86.
4. If the barcode line or QR symbol data does not match or does not exist, a “Reject” message 88 is displayed on the monitor.
5. If the barcode line data or QR symbol does match, a request to enter the customer PIN number is displayed on the monitor to verify the customer identity.
6. The customer then enters his PIN number 92 and the entered PIN number is compared 90 with the decoded PIN number on the check.
7. If a PIN match is not found, a “Reject” message 96 is displayed on the monitor.
8. If a PIN match is found, an “Accept Check” message 98 is displayed on the monitor and the program ends 100.

The use of a PIN number and signatures encoded on personal checks will go a long way to establishing the identity of the check writer, since a thief is not likely to know the PIN number or signature associated with a checking account for stolen checks. Additional method steps which add to the effectiveness of the check fraud prevention method described above are the following optional steps: In encrypting the line of machine-only readable symbols that contain the check data on each check, the encryption code key may be made selective by the operator, who may periodically change the key. This would apply only to bank and business printed checks and not to personal checks, where this would not be practical.

Regarding banks and businesses which have taken most of the serious check fraud losses: if the above-described system of check printing by banks and industry is used, further security measures may be added to prevent fraud. The above-described security measure of periodically changing the encryption code key for the line of symbols on a check, is an example. All banks and companies using the above-described method would have to be confidentially notified of the key code changes in order to incorporate them in a timely fashion. There are other similar security measures that may be added to the established fraud prevention system without the introduction of additional software or equipment.

In the discussion of the equipment used for implementing the method of the present invention, the use of reader/decoder devices was described. This equipment is not new and is currently used at many establishments including banks at check entry points. Modified and/or additional reader/decoder scanner heads will be required. These heads will be programed for reading and decoding the line of symbols encrypted and added during check printing. The added equipment cost required by all system users will therefore be comparatively small. Alternative embodiments and modifications may be apparent to those skilled in the art. These alternatives and modifications are considered to be within the spirit and scope of the present invention.

What is claimed is:

1. An improved method for current check fraud prevention for printing a check, wherein the improved method comprises the steps of:
(a) reading all check data to be printed on a check face including data not printed on said check face;
(b) converting said check data to a line of machine-only readable symbols, using a specially encoded, key-selectable encryption algorithm;
(c) printing said line of machine-only readable symbols containing check data, above the MICR line of symbols on the lower face of said check;
whereby, the addition of said line of machine-only readable symbols permits the detection of any unauthorized changes made to the printed and unprinted data on said check.

2. The method according to claim 1, further includes replacing said line of machine-only readable symbols containing check data, above the MICR line of symbols on the lower face of said check with a QR code printed at a center location on said check.

3. The method according to claim 1, wherein said encrypted check data includes a signature.

4. The method according to claim 1, wherein said encrypted check data includes a manufacturer's identification.

5. The method according to claim 1, wherein said method further includes in step (b):
changing periodically, the key to the encryption code used to produce said line of machine-only readable symbols containing check data, in response to input from a system operator.

6. A method of verifying checks to prevent check fraud, for verification systems having a reader/decoder device connected to a computer, for use with checks that have, printed on their face, a specially encoded, key-selectable encrypted line of machine-only readable symbols, the method comprising the steps of:
(a) inserting a presented check in said reader/decoder for scanning;
(b) reading all printed check data on the face of said check and decoding said specially encoded, key-selectable encrypted line of machine-only readable symbols which includes data printed and not printed on said check face, producing a decoded line of check data;
(c) comparing said printed check data with said decoded line of check data to determine if they match;
(d) displaying on a monitor, a “Reject” message if no match is found;
(e) displaying on a monitor, if a match is found, said decoded line of check data for teller or cashier review;
(f) displaying on a monitor after a short time for review, a request for teller input: “Transmit the data to central processor for analysis? Yes or No”;
(g) ending program If teller input reply is “No”, else,
(h) transmitting said decoded line of check data to said central processor and requesting analysis for errors or other reasons for rejection including check duplication;
(i) displaying on said monitor a “Reject” message or an “OK (Accept)” message depending on the response received from said central processor after check analysis;
(j) ending program.

7. The method according to claim 6, wherein said encrypted check data includes a signature.

8. The method according to claim 6, wherein said encrypted check data includes a manufacturer's identification.

9. The method of verifying checks according to claim 6, further including in step (a):
inputting to said computer, a changed key to the encryption code used to produce said line of machine-only readable symbols containing check data when such change is required.

10. A method of verifying checks to prevent check fraud, for verification systems having a reader/decoder device connected to a computer, for use with checks that have, printed on their face, a specially encoded, key-selectable encrypted readable QR code symbol that contains all check face data and non-printed data, the method comprising the steps of:
(a) inserting a presented check in said reader/decoder for scanning;
(b) reading all printed check data on the face of said check and decoding said specially encoded, key-selectable encrypted QR code readable symbol, producing a decoded line of check data;
(c) comparing said printed check data with said decoded line of check data to determine if they match;
(d) displaying on a monitor, a “Reject” message if no match is found;
(e) displaying on a monitor, if a match is found, said decoded line of check data for teller or cashier review;
(f) displaying on a monitor after a short time for review, a request for teller input: “Transmit the data to central processor for analysis? Yes or No”;
(g) ending program If teller input reply is “No”, else,
(h) transmitting said decoded line of check data to said central processor and requesting analysis for errors or other reasons for rejection including check duplication;
(i) displaying on said monitor a “Reject” message or an “OK (Accept)” message depending on the response received from said central processor after check analysis;
(j) ending program.

11. The method of verifying checks according to claim 10, further including in step (a):
inputting to said computer, a changed key to the encryption code used to produce said line of machine-only readable symbols containing check data when such change is required.

12. The method according to claim 10, wherein said encrypted check data includes a signature.

13. The method according to claim 10, wherein said encrypted check data includes a manufacturer's identification.
